(19) United States
(12) Patent Application Publication
(10) Pub. No.: US 2010/0060932 A1
(43) Pub. Date: Mar. 11, 2010

(54) Image processing apparatus, information processing method, and computer program product

(75) Inventor: Mitsugu Matsushita, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/585,131

(22) Filed: Sep. 4, 2009

(30) Foreign Application Priority Data
Sep. 11, 2008 (JP) 2008-232909

(51) Int. Cl. G06F 15/00

(52) U.S. Cl. 358/1.15

(57) ABSTRACT

An image processing apparatus includes a job-data analyzing unit configured to analyze print job data to check a command contained in the print job data; an image generating unit configured to generate an image corresponding to the print job data analyzed by the job-data analyzing unit; a value acquiring unit configured to acquire a value of an item from the command contained in the print job data analyzed by the job-data analyzing unit; a code generating unit configured to generate a code for the value acquired by the value acquiring unit; a superimposing unit configured to superimpose the code generated by the code generating unit onto the image generated by the image generating unit; and an instruction output unit configured to output an instruction to the image generating unit to generate the image and output an instruction to the value acquiring unit to acquire the value.

### CROSS-REFERENCE TO RELATED APPLICATIONS

The present application claims priority to and incorporates by reference the entire contents of Japanese Patent Application No. 2008-232909 filed in Japan on Sep. 11, 2008.

### BACKGROUND OF THE INVENTION

1. Field of the Invention

The present invention relates to an image processing apparatus, an information processing method, and a computer program product.

2. Description of the Related Art

A technology of a printer that superimposes a symbol code, such as a bar code, on images to be printed has been known. For example, Japanese Patent Application Laid-open No. 2006-31427 discloses a printer driver that generates image data for a bar code and causes a printer to print the bar code on a recording medium such as a sheet of paper. The printer driver makes it possible to print a symbol code with high quality without depending on the environment of the printer.

Japanese Patent Application Laid-open No. 2004-98695 discloses a system for selecting one of a plurality of bar-code fonts corresponding to different bar-code standards, thereby printing bar codes with high precision with a simple input operation.

Although information contained in print data can be converted into bar codes using the technologies in Japanese Patent Application Laid-open No. 2006-31427 and Japanese Patent Application Laid-open No. 2004-98695, information not contained in print data cannot be converted into bar codes in these technologies. For example, if print job data contains the character string “RECOH”, only a bar code corresponding to the character string “RECOH” can be printed and no additional information can be printed.

In order to improve security and user-friendliness when managing documents, it is preferable that bibliographic information corresponding to a document to be printed or information on a print job is additionally printed onto a recording medium on which images of the document is printed. However, if the information is not contained in print job, in the conventional technology it is not possible to print the information onto the recording medium.

### SUMMARY OF THE INVENTION

It is an object of the present invention to at least partially solve the problems in the conventional technology.

According to an aspect of the present invention, there is provided an image processing apparatus including a receiving unit configured to receive print job data; a storage unit configured to store therein the print job data; a job-data analyzing unit configured to receive the print job data from the storage unit and analyze the print job data to check a command contained in the print job data; an image generating unit configured to generate an image corresponding to the print job data analyzed by the job-data analyzing unit; a value acquiring unit configured to acquire a value of an item from the command contained in the print job data analyzed by the job-data analyzing unit; a code generating unit configured to generate a code for the value acquired by the value acquiring unit; a superimposing unit configured to superimpose the code generated by the code generating unit onto the image generated by the image generating unit; and an instruction output unit configured to output an instruction to the image generating unit to generate the image and output an instruction to the value acquiring unit to acquire the value.

According to another aspect of the present invention, there is provided an information processing method including receiving print job data; storing the print job data in a storage unit; analyzing the print job data in a storage unit to check a command contained in the print job data; image generating including generating an image corresponding to the print job data analyzed at the analyzing; acquiring a value of an item from the command contained in the print job data analyzed at the analyzing; code generating including generating a code for the value acquired at the acquiring; superimposing the code generated at the code generating onto the image generated at the image generating; and outputting an instruction to cause the image generating to generate the image using the print job data and outputting an instruction to cause the acquiring to acquire the value.

According to still another aspect of the present invention, there is provided computer program product comprising a computer usable medium having computer readable program codes embodied in the medium that, when executed, causes a computer to execute an information processing method including receiving print job data; storing the print job data in a storage unit; analyzing the print job data in a storage unit to check a command contained in the print job data; image generating including generating an image corresponding to the print job data analyzed at the analyzing; acquiring a value of an item from the command contained in the print job data analyzed at the analyzing; code generating including generating a code for the value acquired at the acquiring; superimposing the code generated at the code generating onto the image generated at the image generating; and outputting an instruction to cause the image generating to generate the image using the print job data and outputting an instruction to cause the acquiring to acquire the value.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram that illustrates a functional configuration of an image processing apparatus according to an embodiment of the present invention;

FIG. 2 is a block diagram of an image processing apparatus according to a first example of the embodiment;

FIG. 3 is a flowchart of a process for printing images together with bar codes by using analyzed print job data according to the first example;

FIG. 4 shows an example of print job data processed by the image processing apparatus according to the first example;

FIG. 5 is a block diagram of an image processing apparatus according to a second example of the embodiment;

FIG. 6 is a flowchart of a process for printing images together with bar codes by using analyzed print job data according to the second example;

FIGS. 7 to 9 are screenshots for prompting a user to input a print instruction to a print instructing unit shown in FIG. 5; and

FIG. 10 is a hardware block diagram of a computer that performs functions of the image processing apparatus according to the embodiment.

### DETAILED DESCRIPTION OF THE PREFERRED EMBODIMENTS

Exemplary embodiments of the present invention are explained in detail below with reference to the accompanying drawings.

In the embodiment, a code means an image, such as a two-dimensional bar code, generated by conversion of information or a form of information, such as an image watermark, embedded in images.

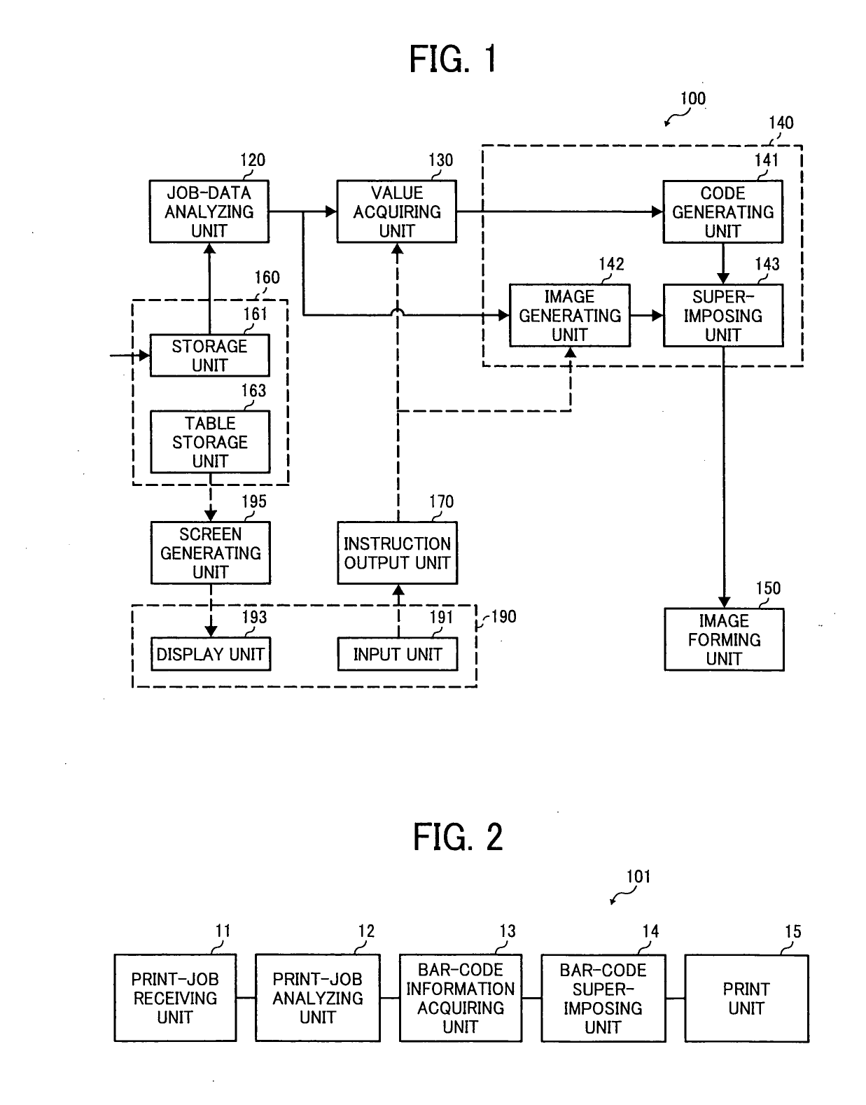

FIG. 1 is a block diagram that illustrates a functional configuration of an image processing apparatus 100 according to an embodiment of the present invention. The image processing apparatus 100 analyzes input job data, superimposes a code, such as a bar code, on image data corresponding to the job data, and forms images with the code on a recording medium. The image processing apparatus 100 includes a job-data analyzing unit 120, a value acquiring unit 130, a code superimposing section 140, an image forming unit 150, a storage section 160, an instruction output unit 170, a user interface (I/F) section 190, and a screen generating unit 195.

The job-data analyzing unit 120 analyzes input print job data. The input print job data is in, for example, a printer job language (PJL). The job-data analyzing unit 120 analyzes each command in the print job data, thereby acquiring conditions of a print process, or the like.

The value acquiring unit 130 acquires a value of an item corresponding to a code generate command contained in the print job data analyzed by the job-data analyzing unit 120. It is preferable that the code generate command is defined as a PJL command. The code generate command contains arguments indicating items such as time and date or identification information on an apparatus. The value acquiring unit 130 acquires a value corresponding to an item that is an argument contained in the code generate command.

If a value to be acquired by the value acquiring unit 130 is, for example, time and date or identification information on an apparatus, the value acquiring unit 130 acquires the value from information stored in a storage unit, or the like, included in the image processing apparatus 100. A value stored in the image processing apparatus 100 is, for example, a value contained in a management information base (MIB).

If a value to be acquired by the value acquiring unit 130 is, for example, information about a document to be printed based on print job data, the value acquiring unit 130 accesses the storage unit in which the information is stored, thereby acquiring the value. An example of information about the document is bibliographic information. The information about the document can be stored in the storage unit or a different not-shown storage unit connected to the image processing apparatus 100 via a network.

If a value to be acquired by the value acquiring unit 130 is stored in a different storage unit, the image processing apparatus 100 accesses the different storage unit via a communication unit (not shown), or the like.

The code superimposing section 140 generates a code, such as a bar code, based on a code generate command contained in print job data and superimposes the generated code on image data generated by using the print job data. The code superimposing section 140 includes a code generating unit 141, an image generating unit 142, and a superimposing unit 143.

The code generating unit 141 generates a code in accordance with a code generate command. A code generated by the code generating unit 141 contains information that is a value of an item acquired by the value acquiring unit 130. A code generated by the code generating unit 141 is a two-dimensional code such as a bar code or a code such as a watermark embedded in images.

The image generating unit 142 generates images based on print job data. For example, the image generating unit 142 generates image data by rendering based on analyzed print job data, and the generated image data is loaded into a memory (not shown).

The superimposing unit 143 superimposes a code generated by the code generating unit 141 on image data generated by the image generating unit 142. If the code superimposed by the superimposing unit 143 is, for example, a two-dimensional code such as a bar code, the code is located at a predetermined position in the image data. If the code superimposed by the superimposing unit 143 is, for example, a watermark, the code is embedded in the image data using a predetermined method.

The image forming unit 150 forms (prints) images with the code superimposed by the code superimposing section 140 on a recording medium (paper).

The storage section 160 stores therein input print job data, and the like. The storage section 160 includes a storage unit 161 and a table storage unit 163. It is preferable that the storage unit 161 and the table storage unit 163 are configured as a hard disk drive (HDD) or a memory.

Input print job data is first stored in the storage unit 161. A plurality of sets of print job data can be stored in the storage unit 161. Each print job is stored in a standby state until an instruction for image formation is received from a user.

The table storage unit 163 stores therein a table that contains a plurality of combinations of different code generate commands. The instruction output unit 170 outputs one of the combinations contained in the table to the value acquiring unit 130. The value acquiring unit 130 performs processing corresponding to the code generate commands included in the combination. Thus, among the code generate commands included in the print job data, information corresponding to the code generate commands included in the specified combination is generated as a code.

User instructions for the image processing apparatus 100 are input via the user I/F section 190. A screen for indicating the state of the image processing apparatus 100 or for prompting the user to input instructions is displayed by the user I/F section 190. The user I/F section 190 includes an input unit 191 and a display unit 193. The user inputs the user instructions by using the input unit 191. The input unit 191 is, for example, a keyboard or a mouse.

The screen for prompting the user to input instructions is displayed on the display unit 193. The entry screen displayed on the display unit 193 prompts the user to input instructions for selecting one or more sets of print job data from a plurality of sets of print job data stored in the storage unit 161. Furthermore, the entry screen displayed on the display unit 193 prompts the user to input instructions for selecting one or more combinations from the table stored in the table storage unit 163.

Although the input unit 191 and the display unit 193 are shown as separate units, they can be configured as a single operation panel. Moreover, although the input unit 191 and the display unit 193 belong to the image processing apparatus 100 in the embodiment, instead, the input unit 191 or the display unit 193 can be connected to a not-shown host computer that is connected to the image processing apparatus 100 via a network.

The screen generating unit 195 generates a screen to be displayed on the display unit 193. The screen generated by the screen generating unit 195 displays, for example, information stored in the storage section 160.

FIG. 2 is a block diagram of an image processing apparatus 101 according to a first example of the embodiment. The image processing apparatus 101 has the same function and the same configuration as those of the image processing apparatus 100. The image processing apparatus 101 includes a print-job receiving unit 11, a print-job analyzing unit 12, a bar-code information acquiring unit 13, a bar-code superimposing unit 14, and a print unit 15.

The print-job receiving unit 11 receives print job data from a not-shown personal computer (PC). The print-job analyzing unit 12 analyzes the print job data received by the print-job receiving unit 11. The print-job analyzing unit 12 determines whether the print job data contains a command that requires bar-code conversion (hereinafter, “bar-code conversion command”).

The bar-code information acquiring unit 13 acquires information that is to be converted into a bar code. The bar-code information acquiring unit 13 acquires such information from, for example, a storage unit of the image processing apparatus 101 itself, or from a server, or the like, connected to the image processing apparatus 101 via a network. The information acquired by the bar-code information acquiring unit 13 is referred to as “bar-code information”.

The bar-code information is, for example, information about time and date, the serial number of the image processing apparatus 101 or the apparatus from which the print job data is received, information about a network connected to the image processing apparatus 101, or information about a user who gave the instruction to print the print job.

Furthermore, the bar-code information is, for example, a value of an item corresponding to a bar-code conversion command contained in print job data. The bar-code information acquiring unit 13 acquires the item from the analyzed print job data and then acquires a value corresponding to the item from a storage unit (not shown) included in the image processing apparatus 101.

If the bar-code conversion command corresponds to “document ID”, the bar-code information acquiring unit 13 makes an inquiry to a server, or the like, in which document data corresponding to the print job data is stored, thereby acquiring additional information such as “creator”, “creation date”, and “document name” of the document data.

The bar-code superimposing unit 14 converts the bar-code information acquired by the bar-code information acquiring unit 13 into a bar-code image and superimposes the bar-code image on images to be printed. The images to be printed are generated based on the analyzed print job data.

The print unit 15 prints images with bar-code images superimposed by the bar-code superimposing unit 14 onto a recording medium such as a sheet of paper.

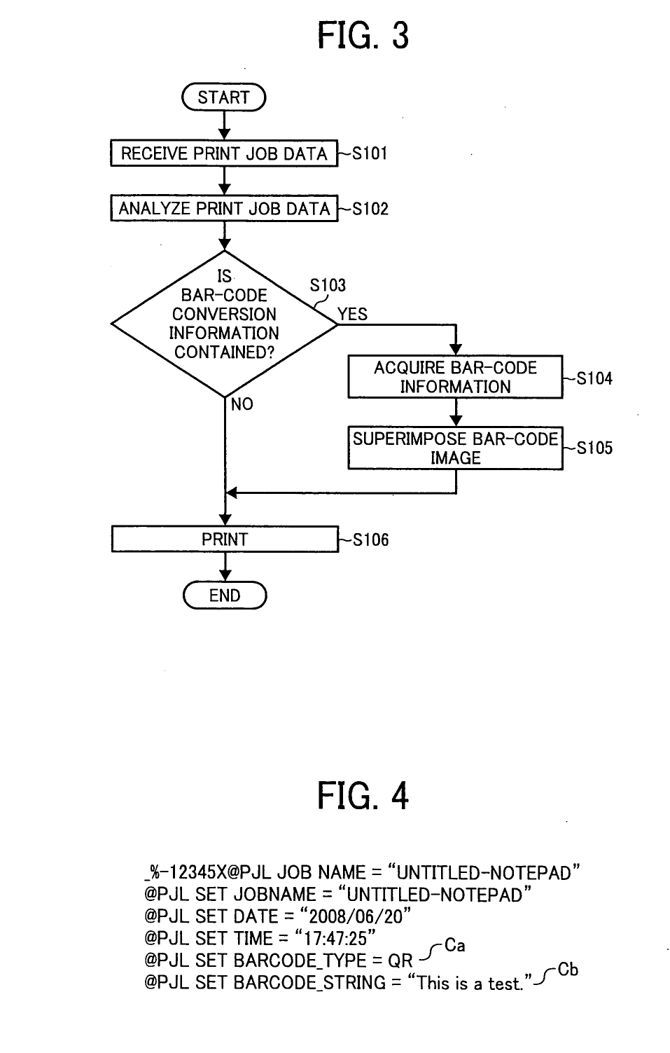

FIG. 3 is a flowchart of a process for printing images along with bar codes by using analyzed print job data. The print-job receiving unit 11 receives print job data (Step S101). The print-job analyzing unit 12 analyzes the print job data received at Step S101 (Step S102).

The bar-code information acquiring unit 13 determines whether the print job data analyzed at Step S102 contains information that is to be converted into a bar code (hereinafter, “bar-code conversion information”) (Step S103). If it is determined that the print job data contains the bar-code conversion information (Yes at Step S103), the process control proceeds to Step S104. If it is determined that the print job data does not contain the bar-code conversion information (No at Step S103), the process control proceeds to Step S106.

The bar-code information acquiring unit 13 acquires bar-code information based on the bar-code conversion information contained in the print job data analyzed at Step S102 (Step S104). The bar-code superimposing unit 14 then generates a bar-code image based on the bar-code information acquired at Step S104 and superimposes the bar-code image on images generated by using the print job data (Step S105).

After Step S103 or S105, the images generated based on the print job data are printed (Step S106). If it is determined that the print job data contains the bar-code conversion information at Step S103, images with a bar-code image superimposed are printed.

FIG. 4 depicts an example of print job data that can be handled by the image processing apparatus 101. The print job data shown in FIG. 4 is written in a PJL. A command Ca contained in the print job data indicates whether the bar-code conversion information is present. The command Ca has an argument “QR”. The argument “QR” is a value indicative of a type of a bar code.

A command Cb contained in the print job data corresponds to the bar-code conversion information. An argument “This is a test.” in the command Cb is the bar-code information. It is not mandatory that the bar-code information is contained in the print job data. That is, the bar-code information can be stored in a storage unit of the image processing apparatus 101 itself.

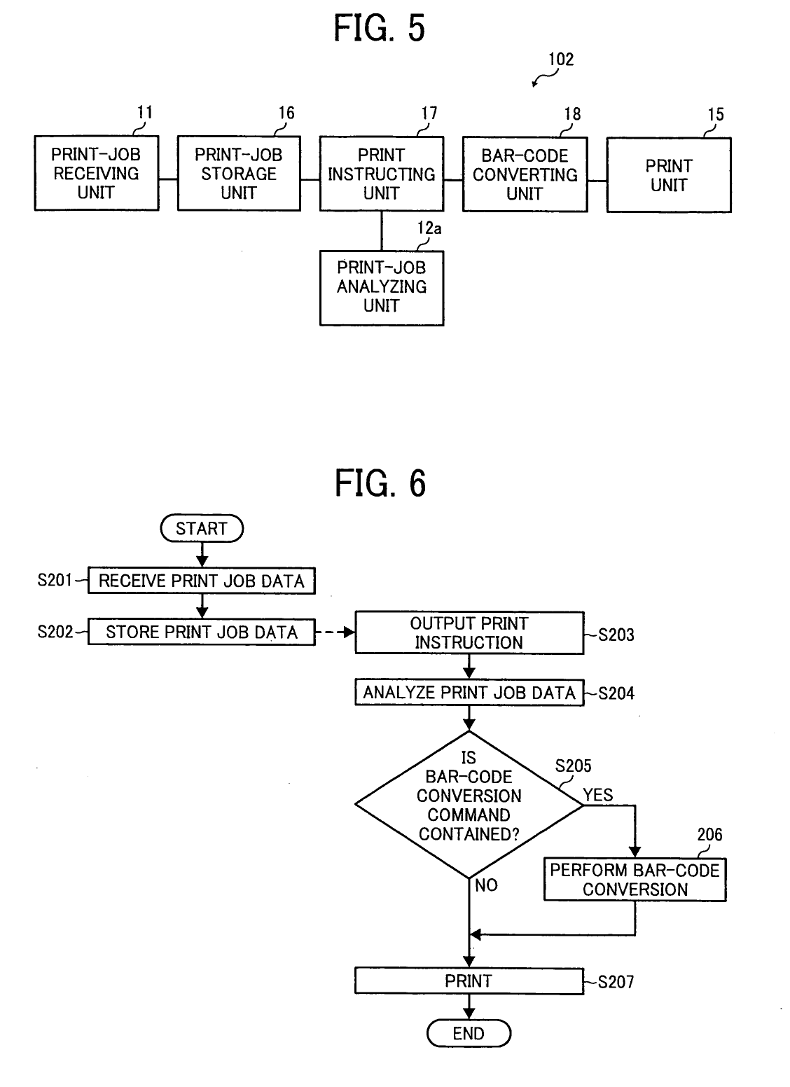

FIG. 5 is a block diagram of an image processing apparatus 102 according to a second example of the embodiment. The image processing apparatus 102 has the same function and the same configuration as those of the image processing apparatus 100 and the image processing apparatus 101. The image processing apparatus 102 includes the print-job receiving unit 11, a print-job analyzing unit 12a, the print unit 15, a print-job storage unit 16, a print instructing unit 17, and a bar-code converting unit 18. The components that perform the same function and the same operation as those shown in FIG. 2 are indicated with the same reference numerals in FIG. 5, and their explanations are omitted.

The print-job storage unit 16 stores therein print job data received by the print-job receiving unit 11. It is preferable that the print-job storage unit 16 stores therein a plurality of sets of print job data. The print-job storage unit 16 is, for example, an HDD.

The print instructing unit 17 selects target print job data from a plurality of sets of print job data stored in the print-job storage unit 16 and then outputs a print instruction. For example, the print instructing unit 17 outputs an instruction that is input by a user based on a list of print job data displayed on the display unit 193. It is possible that the print instructing unit 17 outputs a print instruction each time one set of print job data is stored in the print-job storage unit 16.

Furthermore, it is possible to configure so that the print instructing unit 17 outputs an instruction for bar-code conversion based on an item of bar-code conversion information as determined in advance. For example, a bar-code settings file is stored in a storage unit (not shown). The bar-code conversion information is contained in the bar-code settings file. Specifically, if “Date, Time, SerialNumber, UserName” are contained in the bar-code settings file, information about date and time, a serial number, and a user name is converted into bar codes.

The print-job analyzing unit 12a analyzes print job data for which the print instructing unit 17 has output the instruction and determines whether the print job data contains a bar-code conversion command. Furthermore, it is preferable that the print-job analyzing unit 12a determines whether the print job data contains a bar-code font. If the print job data contains a bar-code conversion command and a font used for bar-code conversion, the specified font is used for the bar-code conversion without generating bar-code images.

If the print-job analyzing unit 12a determines that the print job data contains a bar-code conversion command, the bar-code converting unit 18 generates a bar code corresponding to the bar-code conversion command and adds the generated bar code to images generated using the print job data.

It is preferable that, if the print job data is written in a PJL, it is determined whether the print job data contains a bar-code conversion command by determining whether a PJL command used for bar codes is present. More specifically, for example, if “@PJL BARCODE” is written in a print job that is print job data, it is determined that the bar-code conversion needs to be performed.

It is preferable that the bar-code converting unit 18 is configured as an application program interface (API). For example, it is implemented in a form of AddBarcode (printimage, barcodeinfo). The “printimage” is an argument indicating a bar-code image and the “barcodeInfo” is an argument indicating bar-code conversion information. Thus, if the print instructing unit 17 is implemented as an application, it is possible to perform the bar-code conversion by using the API.

Moreover, the bar-code converting unit 18 can embed a watermark on images instead of converting the information into a bar code.

If the print instructing unit 17 processes a plurality of commands that requires different bar-code conversion, it is preferable that the print instructing unit 17 is implemented as an application corresponding to each of the commands. For example, it is preferable that application 1 is implemented to convert information about time and date and a serial number into bar codes, and application 2 is implemented to convert user information and information about an identification name of a print job into bar codes. Thus, the applications 1 and 2 are switched over depending on the information to be converted into bar codes.

FIG. 6 is a flowchart of a process for printing images along with bar codes according to the second example. In the example of the process shown in FIG. 6, after the print job data is stored in the print-job storage unit 16, images generated based on the print job data are printed. The print-job receiving unit 11 receives print job data (Step S201). The print job data received at Step S201 is stored in the print-job storage unit 16 (Step S202).

The print instructing unit 17 outputs a print instruction for the print job data stored at Step S202 (Step S203). The process control proceeds from Step S202 to Step S203 upon receiving an instruction from a user or an event such that one set of print job data is stored in the print-job storage unit 16.

The print-job analyzing unit 12a analyzes the print job data for which the print instruction has been output at Step S203 (Step S204). The bar-code converting unit 18 determines whether the print job data analyzed at Step S204 contains a bar-code conversion command (Step S205). If it is determined that the analyzed print job data contains a bar-code conversion command (Yes at Step S205), the process control proceeds to Step S206. If it is determined that the analyzed print job data does not contain a bar-code conversion command (No at Step S205), the process control proceeds to Step S207.

The bar-code converting unit 18 performs the bar-code conversion corresponding to the bar-code conversion command (Step S206).

Images generated using the print job data for which the print instruction has been output at Step S203 are printed (Step S207). If it is determined that the analyzed print job data contains a bar-code conversion command at Step S205, a bar-code image generated by the bar-code conversion at Step S206 is superimposed on images to be printed.

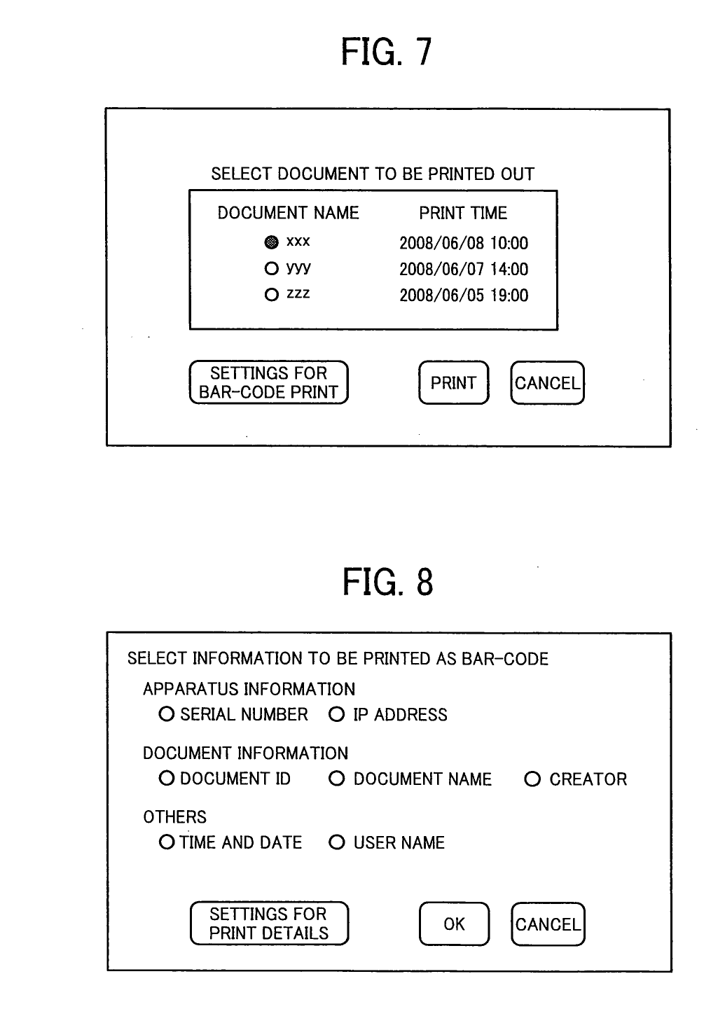

FIGS. 7 to 9 are screenshots for prompting a user to input a print instruction to the print instructing unit 17. Three sets of print job data are displayed on the screen shown in FIG. 7. In this example, a radio button for a document “xxx” arranged on the top is selected. When a button “settings for bar-code print” is pressed on the screen shown in FIG. 7, the screen is switched to the entry screen shown in FIG. 8.

The screen shown in FIG. 8 prompts the user to select information to be superimposed as bar codes. The user can select items to be superimposed as bar codes with respect to three pieces of information, i.e., “apparatus information”, “document information”, and “others”.

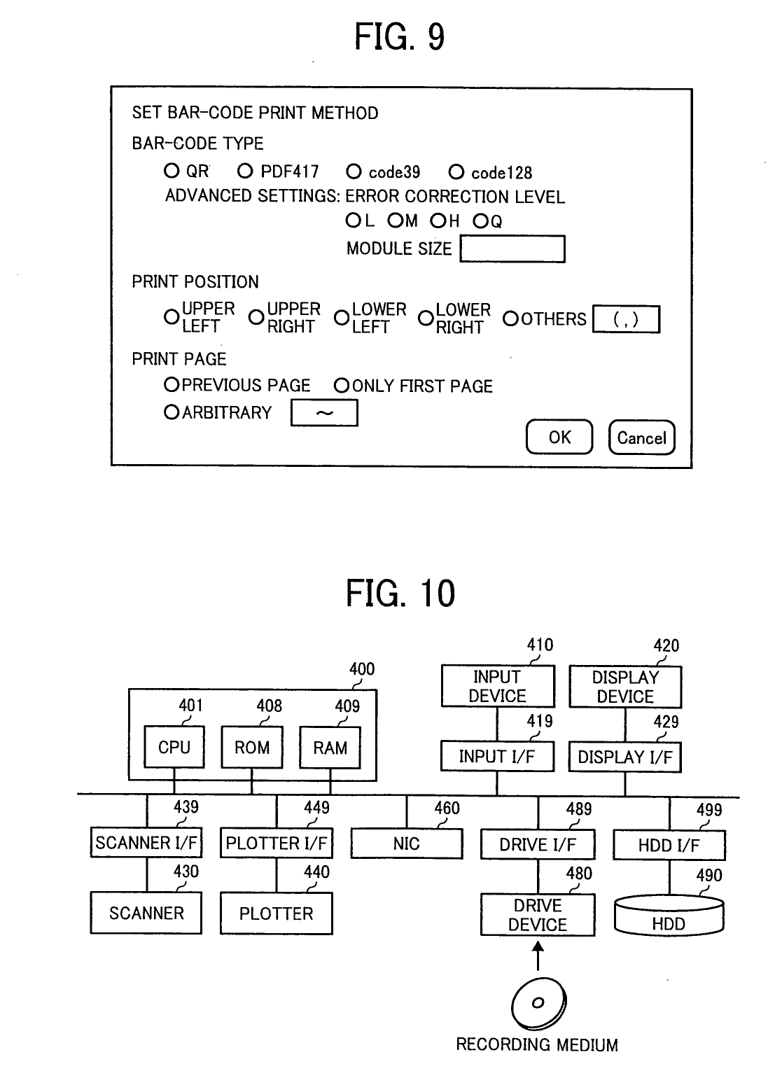

The screen shown in FIG. 9 is used to set positions where the bar codes are to be superimposed, the type of the bar codes, and the like. The user can specify settings for “bar-code type”, “print position”, and “print page” on the screen shown in FIG. 9. The “print” of the bar codes as indicated in FIGS. 8 and 9 means that the bar codes superimposed on images are printed onto a recording medium.

FIG. 10 is a block diagram of a computer that performs the functions of the image processing apparatus 100, 101, or 102. The computer includes a main processing unit 400, an input device 410, a display device 420, a scanner 430, a plotter 440, a network interface card (NIC) 460, a drive device 480, an HDD 490, an input I/F 419, a display I/F 429, a scanner I/F 439, a plotter I/F 449, a drive I/F 489, and an HDD I/F 499.

The main processing unit 400 performs each function by executing computer programs. The main processing unit 400 includes a central processing unit (CPU) 401, a read-only memory (ROM) 408, and a random access memory (RAM) 409. The CPU 401 controls each device included in the computer by executing computer programs. Computer programs, parameters, or the like, are stored in the ROM 408 and the computer programs or the parameters are fed to the CPU 401. The RAM 409 is used as a working memory when the CPU 401 executes computer programs.

The input device 410 can be, for example, a keyboard or a mouse. Instructions, or the like, to the computer are input by the input device 410. The state of the computer, or the like, is displayed on the display device 420. The scanner 430 optically reads images of an original, thereby generating image data. The plotter 440 forms images on a recording medium.

The NIC 460 performs a function of an I/F for connecting the computer to an external device via a network and controls the connection. The drive device 480 reads information from a recording medium inserted into the drive device 480 or stores information in the recording medium. The HDD 490 is a storage unit that stores therein a large volume of data.

The input I/F 419, the display I/F 429, the scanner I/F 439, the plotter I/F 449, the drive I/F 489, and the HDD I/F 499 connect the input device 410, the display device 420, the scanner 430, the plotter 440, the drive device 480, and the HDD 490, respectively, to the main processing unit 400 via a bus.

Correspondence relationships of the components shown in FIGS. 1, 2, and 5 are as follows: the print-job analyzing unit 12 and the print-job analyzing unit 12a correspond to the job-data analyzing unit 120; the bar-code information acquiring unit 13 corresponds to the value acquiring unit 130; the bar-code superimposing unit 14 and the bar-code converting unit 18 correspond to the code superimposing section 140; the print unit 15 corresponds to the image forming unit 150; the print-job storage unit 16 corresponds to the storage section 160; and the print instructing unit 17 corresponds to the instruction output unit 170.

Although the embodiment of the present invention has been described above, the present invention is not limited to the embodiment. Various changes can be made within the scope of the present invention.

According to an aspect of the present invention, it is possible to provide an image processing apparatus, an information processing method, and a computer program product that can easily superimpose information not contained in print job data on images of a document to be printed on a recording medium.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a receiving unit configured to receive print job data;
a storage unit configured to store therein the print job data;
a job-data analyzing unit configured to receive the print job data from the storage unit and analyze the print job data to check a command contained in the print job data;
an image generating unit configured to generate an image corresponding to the print job data analyzed by the job-data analyzing unit;
a value acquiring unit configured to acquire a value of an item from the command contained in the print job data analyzed by the job-data analyzing unit;
a code generating unit configured to generate a code for the value acquired by the value acquiring unit;
a superimposing unit configured to superimpose the code generated by the code generating unit onto the image generated by the image generating unit; and
an instruction output unit configured to output an instruction to the image generating unit to generate the image and output an instruction to the value acquiring unit to acquire the value.

2. The image processing apparatus according to claim 1, wherein
when the job-data analyzing unit determines that the print job data contains a plurality of code generate commands, the instruction output unit outputs an instruction to the value acquiring unit with respect to each combination of different code generate commands, and
the value acquiring unit acquires a value of an item corresponding to the code generate commands for which the instruction output unit outputs the instruction.

3. The image processing apparatus according to claim 1, wherein the instruction output unit outputs an instruction to both the image generating unit and the value acquiring unit each time one set of print job data is analyzed by the job-data analyzing unit.

4. The image processing apparatus according to claim 1, further comprising a screen generating unit configured to generate an entry screen to prompt a user to input an instruction for generating an image corresponding to print job data stored in the storage unit, wherein
the instruction output unit outputs an instruction for the print job data for which the user inputs the instruction via the entry screen.

5. The image processing apparatus according to claim 4, wherein if a plurality of sets of print job data is stored in the storage unit, the entry screen displays a list of identification information on the sets of print job data.

6. The image processing apparatus according to claim 2, further comprising a table storage unit configured to store therein a table containing combinations of the different code generate commands, wherein
the instruction output unit outputs an instruction to the value acquiring unit with respect to one or more combinations among the combinations contained in the table.

7. The image processing apparatus according to claim 2, further comprising a screen generating unit configured to generate an entry screen to prompt a user to input a combination of different code generate commands for which the instruction output unit is to output an instruction, wherein
the instruction output unit outputs an instruction to the value acquiring unit with respect to the combination of the different code generate commands for which the user inputs the instruction via the entry screen.

8. The image processing apparatus according to claim 1, wherein the item is any one of information about time and date, identification information on the image processing apparatus, identification information on a job for generating an image based on the print job data, and identification information on a user that corresponds to the print job data.

9. The image processing apparatus according to claim 1, further comprising an image forming unit configured to form an image with the code superimposed on a recording medium.

10. An image processing method comprising:
receiving print job data;
storing the print job data in a storage unit;
analyzing the print job data in a storage unit to check a command contained in the print job data;
image generating including generating an image corresponding to the print job data analyzed at the analyzing;
acquiring a value of an item from the command contained in the print job data analyzed at the analyzing;
code generating including generating a code for the value acquired at the acquiring;
superimposing the code generated at the code generating onto the image generated at the image generating; and
outputting an instruction to cause the image generating to generate the image using the print job data and outputting an instruction to cause the acquiring to acquire the value.

11. A computer program product comprising a computer usable medium having computer readable program codes embodied in the medium that, when executed, causes a computer to execute an information processing method comprising:
receiving print job data;
storing the print job data in a storage unit;
analyzing the print job data in a storage unit to check a command contained in the print job data;
image generating including generating an image corresponding to the print job data analyzed at the analyzing;
acquiring a value of an item from the command contained in the print job data analyzed at the analyzing;
code generating including generating a code for the value acquired at the acquiring;
superimposing the code generated at the code generating onto the image generated at the image generating; and
outputting an instruction to cause the image generating to generate the image using the print job data and outputting an instruction to cause the acquiring to acquire the value.
